(19) United States
(12) Patent Application Publication
(10) Pub. No.: US 2016/0042413 A1
(43) Pub. Date: Feb. 11, 2016

(54) Systems and Methods for the Recording and Selective Distribution and Selective Communal Analysis of Consumer Reviews

(71) Applicant: Stephen Joseph Flood, Dublin (IE)

(72) Inventor: Stephen Joseph Flood, Dublin (IE)

(21) Appl. No.: 14/822,876

(22) Filed: Aug. 10, 2015

Related U.S. Application Data
(60) Provisional application No. 62/035,445, filed on Aug. 10, 2014.

(51) Int. Cl. G06Q 30/02; G06Q 50/00

(52) U.S. Cl. CPC G06Q 30/0282; G06Q 50/01

(57) ABSTRACT

A system and method for the recording and selective distribution and selective communal analysis of commercial and non-commercial consumer reviews, which are prioritized on the basis of hierarchical geographical location or hierarchical chronological value. Also described is a system offered to users to create reviews and or review reviews, with categories and to ascribe importance in terms of physical proximity or in the case non-physically dependent services and products, temporal proximity. Also described is a system whereby authors whose reviews lead to further reviews by affiliated parties and in commercial traffic may be rewarded by a benefiting commercial partner.

### CROSS-REFERENCE TO RELATED APPLICATIONS

This application claims priority to U.S. Provisional Application No. 62/035,445 filed on Aug. 10, 2014, now pending, the disclosure of which is incorporated herein by reference.

### FIELD OF THE DISCLOSURE

The disclosure relates to systems and methods for the recording and selective distribution and selective communal analysis of consumer reviews.

### BACKGROUND OF THE DISCLOSURE

This disclosure seeks to solve an important problem in the collection, aggregation and dissemination of personal and consumer reviews and impressions. Specifically the Internet does not deliver real and effective peer reviews. A user does not know what their peers, friends, and families like and dislike without carrying out direct observation or engaging in direct conversation. There is no service that attempts to deliver a solution whereby what is important or valuable to one person may also be valuable to related parties and or parties who are from the same social demographic and age profile. In essence what is important to one user may be important to another user if they are alike and/or know each other.

By way of background, observe the following. Popular social media services (such as Facebook) allow sharing of social content, provide a basis for interaction and the sharing of ideas as well as keeping in touch with friends and family. Social comment platforms and information sharing services (such as Twitter) provide users with real time information feeds on matters of interest within a select group. Professional Social Media services (such as LinkedIn) provide users with the ability to review and post details of professional interests and achievements, to interact and share content. Consumer review services (such as Trip Advisor) allow users to comment and share consumer experiences, building profiles of entertainment locations and providing a high quality review system.

Marketers seek ways to attract the attention of their target market audiences by producing content that appeals and stimulates. It is then hoped that this attention will garner followers as a result and the more followers will result in a community and credibility and loyal customers.

Facebook introduced out “likes” as a way for users to flag their approval of a particular posting or service on the network. When one user “likes” something their followers are alerted and attention is then directed towards the content. “Likes” can have a viral effect and very quickly a single post can attract a lot of attention.

A user can have lots of “likes” and the likes can be attributable to almost any type of content. This process can provide a useful indicator of interest to the user's followers at that particular moment in time but it has limited time value and cannot easily be categorized for users. In essence the value is fleeting.

Mobile technology opens up so many possibilities for the Internet, especially the harvesting and distribution of data. The confluence of mobile phones, contact lists, communication capabilities and location awareness means that users can more closely align their physical locations with our peer group collective experiences.

But the prior art fails to address basic consumer problems. For example, if a user wants to buy a shirt, where do people like that user, or people that the user knows and respects, buy shirts? This is the problem that is not addressed in the prior art. Therefore, new systems and methods for the collection, aggregation and dissemination of personal and consumer reviews and impressions are needed in the art.

### BRIEF SUMMARY OF THE DISCLOSURE

One embodiment of the present disclosure can be described as a method performed by a computing system for providing distribution and communal analysis of customer reviews. The computing system has a processor and a memory to perform the steps of the method.

The method comprises receiving a request for an assessment of items-of-interest within a geographic area or chronological space. The request comprises a category and a requesting-user identifier. The item-of-interest may be a physical location, such as a restaurant, or a non-physical item, like a song. The geographic area may be a city, county, state, country, or continent. The chronological space may be all-time, one year, one month, or one day.

The method further comprises obtaining, by the computer system, a user network of relationships between the requesting-user identifier and other user-identifiers.

The method further comprises obtaining, by the computing system, the assessment of one or more items-of-interest. Each assessment comprises a score. The score may be based in part on the requested category, the geographic area or chronological space, and on reviews of the items-of-interest from the other users in the user network. The reviews of the other users are stored in a computer-accessible database. Each review may be weighted based on a hierarchical relationship between each other user and the requesting-user identifier in the user network. The score is further based in part on the geographic proximity between the user and the item-of-interest.

The method may further comprise displaying, by the computing system, a representation of the obtained assessments. The assessments may be displayed based on a degree of relationship within the user network between the requesting-user identifier and other user-identifiers.

The method may further comprise obtaining, by the computer system, a transaction for one or more of the assessed items-of-interest. The method may further comprise validating, by the computer system, the displayed representation based on geographic data or chronological data from the computing system.

Another embodiment of the present disclosure is a method performed by a computing system for providing distribution and communal analysis of customer reviews. The computing system has a processor and a memory to perform the method.

The method comprises receiving, by the computing system, a user network of relationships between a requesting user and other users.

The method further comprises receiving, a review of an item-of-interest within a geographic area or chronological space. The review comprises a category, corresponding physical location, and a relevancy score, wherein the relevancy score is based on the geographical and chronological proximity to the item-of-interest.

The method further comprises obtaining, by the computing system, the assessment of one or more items-of-interest. Each assessment comprises a score. The score is based in part on the received category, geographic area, or chronological space.

The method may further comprise displaying, by the computing system, a representation of the obtained assessments. The method may further comprise transmitting a reward to the user based on the received review. The method may further comprise validating, by the computer system, the review based on geographic data or chronological data from the computing system.

The present disclosure provides a user driven system of relevant timely and useful consumer data. Embodiments of the present disclosure may only require information on what is the reviewer's favorite provider or place for a particular category under degrees of physical space or in degrees of time.

One exemplary embodiment of the present disclosure may ask, within a given geographical space, if the provider is the reviewer's favorite for a particular category, for example, favorite “Burger Restaurant” in the; city, country, or world.

Equally for non-geographical experiences the embodiment may ask the reviewer how valuable a service or experience they are enjoying is in terms of chronological value to them. For example consider when a reviewer attends a concert by their favorite performer this year. They note the concert as their favorite concert that year. The review is shared, with or without their permission, with their friends and with people who are like them, and then anonymously (or in an attributable manner) with the entire network.

In some embodiments, the systems and methods provide a response to the high-volume and low-value data world that is everywhere and instead provides a high-value and low-volume “tribe” (the people the user knows and whose opinions they value) verified data that is meaningful, relevant and delivered conveniently and almost effortlessly to the user.

Reviews can be gathered in a number of different ways. For mobile reviews, the system may use a portable computing device with location reference gathering capabilities (GPS capable), an Internet connection, a loaded application, which can interpret the geographical information and request one or more data packets from a connected online database of locations. The system may serve up a suggestion of where the reviewer is located and provide a list of most likely categories that the location is associated with. The system may suggest to the reviewer the most likely category and request the reviewer to decide if the location and the category are their favorite provider of the category locally, nationally or globally. The user can create their own category for the location too if they wish. The user can then add enhancements to their review if they wish in the form of voice, text, images that will be available on the network and distributed to the reviewer's network. Elements of the review may also be available on the network for wider users but the identity of the reviewer will not be disclosed unless otherwise directed.

In other embodiments, for non-specific geographical service reviews, (that is experiences that do not require a location in order to be accessed and consumed; songs, movies, online services, games, books, speakers, etc.), the review system may allow reviews to be gathered by referencing a registration code unique to the service (accessible, for example, on a website, or searching for the name in a database or some other embodiment of a system that may be used as reference data medium). The code, or service identity, once referenced will allow the system to retrieve and display to the user a request to register a review, for example, by displaying to the user on any connected, logged-in device categories that are commonly associated with the service or predefined by the service owner. The reviewer may then be asked to give a review by indicating that the service is their favorite service for the given category at that time, this year, for all-time, or some other defined amount of time.

The system may use a number of different technologies to identify a service and or location. For example, sound identification technology can be used to identify music, videos, recording artists that are not defined by a single physical located.

The system can use QR codes (quick response codes) that could be displayed on websites or at physical locations within commercial premises. A user could scan a code that is displayed within a commercial establishment (for example on a menu) and in doing so invoke the specific location data for the business and the desired category that the business wishes to be reviewed for.

Service buttons can be added to any websites or applications that, once activated, may invoke the system app and display the referencing services details and allow for the processing of a review.

Searching for data is a primary function of the system. In some embodiments, the system may allow users to search reviews within their connected network. The system may suggest smart reviews based on what similar, yet unconnected profiles, found informative. For example, if a user is traveling to a location they have not been to before they may wish to access review data for that location and consider providers at the location to visit. Users could use the system to find hotels, airlines, travel agents, and restaurants and any other services or products that have a relationship with the destination being researched.

In some embodiments, should the researching user use one of the reviewed providers and also then provide a positive review the initial reviewer may receive a token gratuity in the form of a coupon or some other consideration as a mark of gratitude for making the initial review from the provider. This is a system that may be established with the provider and the system at registration. This benefit will greatly increase the probability that reviews will be made and acted upon and not necessarily abused. If a user wishes to shop for a particular category of clothing such as men's work shoes, they could look up reviews made for the area they are in for providers of men's shoes that come recommended. They can be assured that the reviews are from their network and that they can be trusted.

In other embodiments, if the experience does not match the anticipated expectation the user can modify (i.e., reduce) the value weighting for that reviewer, thereby affording the network of reviews to be self-correcting and bespoke to the reviewer's tastes. Certain networked reviews may become less valuable and others more valuable to each user. For example, one friend might be knowledgeable on music matters, but not on travel. The system can adjust more relevant weightings in certain categories to the users' tastes, thus improving the relative value of the information.

In some embodiments, the monitoring and interaction of reviews within one's network is also a primary function of the system. Reviewers can view the reviews made by connected participants and interact with the reviewer, comment on, or share with others in their network. This allows a community to develop around the information being submitted to the system and to allow networks to quickly benefit from timely reviews that may have a fleeting benefit (for example, a popup temporary shop offering special deals this week only).

In some embodiments, users may wish to comment on new reviews by connected parties, and the conversation may be distributed on other connected social apps. For example, a comment may trigger a tweet or Facebook post, or any other embodiment of social and communication media, yet to be created). For example if a user gives a review for a new gym that has opened in their area, a connected party may wish to ask a question after seeing the review and thus a conversation could ensue. The conversation may be broadcast to connected parties of the commentator and so the information can start to spread and create value as it is shared.

### DESCRIPTION OF THE DRAWINGS

For a fuller understanding of the nature and objects of the disclosure, reference should be made to the following detailed description taken in conjunction with the accompanying drawings, in which:

FIG. 1 is a diagram showing an example of a review process according to one or more embodiments described herein;

FIG. 2 illustrates an example of a search process for one embodiment of the disclosure;

FIG. 3 illustrates one example of a review monitoring and review system according to one embodiment of the disclosure;

FIG. 4 illustrates a possible graphical user interface for one embodiment of the present disclosure; and

FIG. 5 is a diagram of one embodiment of a system according to the present disclosure;

FIG. 6 is a diagram of one embodiment of the system according to the present disclosure;

FIG. 7 is a flowchart illustrating one method according to the present disclosure; and

FIG. 8 is a flowchart illustrating one method according to the present disclosure.

### DETAILED DESCRIPTION OF THE DISCLOSURE

One embodiment of the present disclosure is a method 100 performed by a computing system for providing distribution and communal analysis of customer reviews. The computing system has a processor and a memory. Examples of suitable computing systems include mobile phones, tablets, laptops, and desktop computers.

The method 100 may comprise receiving 101 a request for an assessment of items-of-interest within a geographic area or chronological space. The request may be input into a mobile phone by a user. The user may request one or more items-of-interest. The items-of-interest may be organized by category or by geography (i.e., closest to the current location of the user). The request may also relate to a chronological space, such as items-of-interest that have occurred recently (or will occur in the future). The request comprises a category and a requesting-user identifier. The requesting-user identifier may be a user name unique to the user or another type of unique tracking identifier, such as a cookie.

The method 100 may further comprise obtaining 103 a user network of relationships between the requesting-user identifier and other user-identifiers. The user network may be obtained by the computing system or by a remote computing system, such as a server or API. The network of relationships may describe first, second, and third degree connections between users in the network. The network may also be categorized hierarchically, such that some relationships are weighted more than others. For example, a first degree connection sharing multiple items of interest may be weighted greater than a first degree connection with dissimilar interests. The items of interest could be biographical (i.e. historical, such as attended the same school or lived in the same area), demographic (i.e. the same age, gender, culture, etc.), and user-designated (i.e., where the user designates another user as influential or ignored).

The method 100 may further comprise obtaining 105, the assessment of one or more items-of-interest. Each assessment may comprise a score. The assessment may comprise other data, such as written text, pictures, audio, video, etc. The score may be based in part on the requested category. For example, the results and their scores may be heavily weighted on the category selected by the user. The score may also be based in part on the geographic area or chronological space. The geographic area or chronological space may be designated by the user or automatically determined using the user's computing system. The score may also be based, in part, on reviews of the items-of-interest from the other users in the user network. The reviews of the other users may be stored in a computer-accessible database. Each review may be weighted based on a hierarchical relationship between each other user and the requesting-user identifier in the user network. The score may be further based in part on the geographic proximity between the user and the item-of-interest.

The method 100 may further comprise displaying 107 a representation of the obtained assessments. For example, the obtained assessments may be displayed in a scrollable list on the user's mobile device. The assessments may also be displayed on a map to correspond to the geographic data for each item-of-interest. The assessments may also be displayed on a timeline to correspond to the chronological data for each item-of-interest. The assessments may be displayed based on a degree of relationship within the user network. For example, the user may have the option of viewing only assessments from first and second degree connections.

The method 100 may further comprise obtaining 109 a transaction for one or more of the assessed items-of-interest. For example, the user may be able to purchase the assessed items-of-interest, or initiate a transaction with the locations of interest through their computer system, directly though each assessment.

The method 100 may further comprise validating 111, the displayed representation based on geographic data or chronological data from the computing system. For example, the computing system may verify the current date and location of the user. In the example of future events, the computing system may verify availability based on the user's calendar in the computer system.

The present disclosure can also be described as a method 200 performed by a computing system for providing distribution and communal analysis of customer reviews. The method 200 comprises receiving 201, a user network of relationships between a requesting user and other users. The user network may be a database structure or a link to an existing user network, such as a social media network. The user network may be arranged in nodes, such that each node represents a user. The nodes may contain information relating to the user, such as biographic, demographic, and user-defined information. The nodes may be connected in a weighted-manner such that certain connections are given more weight or deference than other connections.

The method 200 further comprises receiving 203, a review of an item-of-interest within a geographic area or chronological space. The review may comprise a category, corresponding physical location, and a relevancy score. The relevancy score may based on the geographical and chronological proximity to the item-of-interest.

The method 200 further comprises obtaining 205, by the computing system, the assessment of one or more items-of-interest. Each assessment comprises a score, wherein the score is based in part on the received category and the score is based in part on the received geographic area or chronological space.

The method 200 further comprises displaying, 207 by the computing system, a representation of the obtained assessments. The method 200 may further comprise transmitting 209 a reward to the user based on the received review and validating 211 the review based on geographic data or chronological data from the computing system.

In some embodiments, the system is designed to collect, process and distribute within a system network, most favorite reviews for specific categories, by and for specific physical regions or by and for specific timescales.

The term “review” as used herein may include feedback of an experience by a user relating to a system or product or location received or directly experienced.

The term “favorite” as used herein may include, to a user, the most important, most valuable, most favored, of all possible known alternatives at a particular time and or at a particular location or physical space.

The term “physical location” as used herein may include space inhabited by a provider or a system given by a provider. A physical location may be limited to a street, town, city, state, county, country, union, continent, any global location on earth or embodiment thereof.

The term “timescale” as used herein may include a particular measure of time. It may be mean a time frame described as now, this week, this month, this quarter, this year, all time or indefinitely forever or any embodiment of any time frame possible.

The term “system” as used herein may include the system and the technology used to deliver the system, its component parts and its elements, its uses, its methods of delivery, its attributes and processes.

The term “provider” as used herein may include any person or persons or legal entity that in part or in whole provides a system or product that can be used and enjoyed or experienced either with financial consideration or without financial consideration, in a specific physical location or via electronic system provision.

The system's functionality is contingent on a selection of hardware, software, and connectivity to the Internet and a user account being pre-established.

Hardware. In some embodiments, the user will have a mobile computing platform that has location awareness technology built in, such as a GPS sensor or the embodiment of any similar functional system and or device that can fulfill the same use. The device may be a mobile phone, a tablet or any other computational device that has the capability to run programs, connect to the Internet and have the ability to identify its location with in an acceptable threshold.

As technology develops wearable devices that integrate with the human body are possible such as eyewear, watches, contact lens or biomedical implants. Information from the system may be delivered via augmented reality to displays depicting possible locations of interest to users as they pass through an area or look over a map. As long as the device can identify its location and run an Internet connected program such as the system it will be compatible with the system.

For non-mobile versions of the system an Internet browser may be used to support an add on system that would allow Internet users to identify specific sites of interest or media of interest and process a review. For example if a user visited a magazine website and read an article they could decide to invoke the review process by virtue of accessing an add on tool from their browser or any other activation method available. Or if the site provided a link they could click on a system button, which would invoke a web system and allow the processing of a review.

Software. The system can and may be deployed to the device, as an application that once activated will be able to access the devices sensors and begin the evaluation process. The software can be downloaded from any number of application hosting systems such as an app store or equivalent. The software may require the user to establish an account. This may be accomplished in any number of ways, for example by using single sign on protocols from popular systems such as Facebook or Google or by creating a new account by identifying an email address or phone number or biometric credential.

The software may be designed to hold session data and process and display request to the user based on input and environmental parameters collected. In the absence of sufficient device data storage capacity the software may require an Internet connection so that relevant user credentials, environmental data, and user inputs and data requests may be collected and processed.

Database. The system may require a database to be available via the Internet or stored within the device so that connected devices may request data and submit database queries. Datasets may include user accounts, reviews, and locations, providers, categories user networks, and user preferences, communication logs and any other data set and systems that may be required.

System Systems. The system may require a number of systems services to be available. Specifically, but not limited to: a location database, which given a specific set of location references, is able to provide a list of likely locations of interest and or providers: a sound analysis system, that given a clear sound recording, can identify any related media that may be the origin of the sound, such as a music track, television program or a concert or radio station and any other search pertinent related data.

Data. The system may have an extensive dataset of locations augmented with highly accurate location references. Furthermore the system may have a list of categories for each location that can manage effectively while also allowing users to make suggestions as to new categories or create their own custom categories. The database design and structure may allow users to be largely responsible for data generation and moderation. Users may be allowed to submit new locations, related location data, imagery, categories and any other data that may be pertinent to the successful listing of the location system or product.

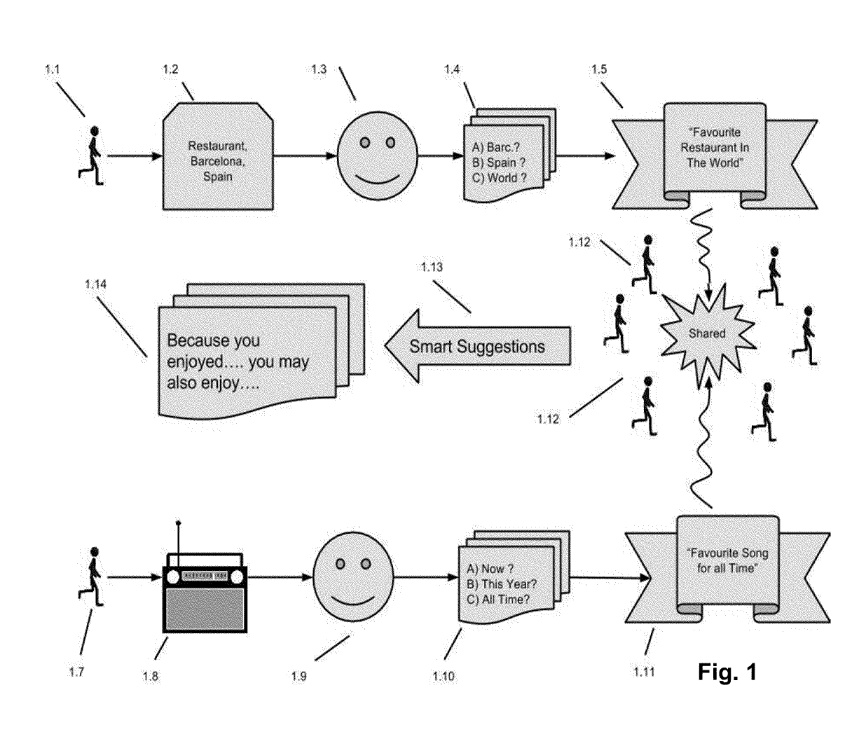

FIG. 1. FIG. 1 shows an example of a review process according to various embodiments described herein.

1.1 Depicts the user.

1.2 Depicts the user in attendance at a location which in this example is a Restaurant in Barcelona, Spain.

1.3 Depicts the user as being very satisfied with the Restaurant and deciding to make a review using the system. The user may open up the app on his device; the device may make a secure connection to the system servers and provide location information such as the location coordinates for the user's mobile device. The system may then send to the app the details of the most likely location for these coordinates being the restaurant.

1.4 The system may also list the most likely category under which reviews for the restaurant are generally listed. The user may decide to accept the location details and the suggested category or change either one. Once satisfied with the listing the user can decide how best to rate the location as being his favorite in Barcelona, Spain, or the world.

1.5 The user may then decide to opt for the option stating that the Restaurant is the user's favorite in the world.

1.6 The system may, governed by user data settings and data protection, make the review system accessible to all connected parties of the user on the network as well as updating the global system with anonymous details of the review.

1.8 In this example the user is listening to a song on the radio and decides that he wishes to process a review.

1.9 The user decides that he wish to process a review via the system app.

1.10 Using a number of different technologies the user can locate the identity of the music by activating his device and loading the system app. The system app will identify the music and provide details of the track and most likely categories under which other users have categorized the track. The user can, if they wish, change the system prompted identity data and change the name of the track and the related categories. The user must now choose the importance of the track to them in terms of time. Is it their favorite track, artist album, for that moment, this year, all time.

1.11 The user chooses “all time”. Should they select another song the next week the previous choice will be listed, as they're favorite for the time up until the second review was made. This way historical favorites may have value but will not be as important in terms of what is popular with the user today, now. The user choices regarding music may also be used by the system to infer choices as to genre, artist and any other embodiment or related data set associated with the initial choices made. This means that if a user chooses consistently classical music tracks, the system may state in the user profile that the user likes classical music in general.

1.12 The system may now make the review available to the known users connected network and anomalously to the entire network.

1.13 The system may know the category chosen by the user and may have a profile of the user that they may then be used to suggest other available options that the user may also be interested in. This may allow the system to promote other qualified locations and or systems to the user.

1.14 The system displays to the user that based on their reviews they may also want to check out other locations and systems that may be of interest. The system might note that listed within the network is another restaurant nearby that is receiving many more positive reviews and that the user may want to visit that location the next time they are in the market for a specific category and restaurant experience in that location.

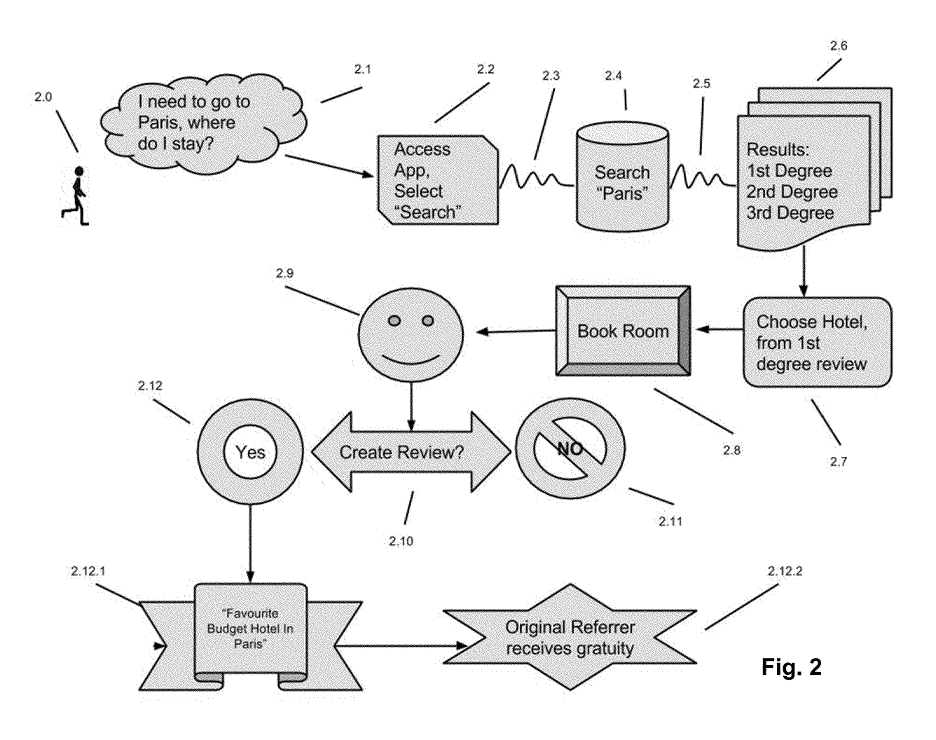

FIG. 2. FIG. 2 illustrates an example of a Search Process for the system application according to various embodiments described herein.

2.0 The user is a registered user of the system app and is considering a trip to a foreign city.

2.1 The user normally might ask friends or family for suggestions or go on the Internet and search review sites for locations to stay and places to visit while visiting a chosen city. In this case the user decides he will stay in Paris, France. The user decides to start his research by invoking the system app and establish what suggestion might be contained therein.

2.2 The user opens the system app on his Internet connected device. He selects the search option.

2.3 The user types in “Paris”, and hits the search command.

2.4 The system application connects to the system database.

2.6 The system database returns data in response to the search to the system app request. The results are displayed in order of preference. The system lists all reviews and locations that have been filed by valued 1^{st} degree contacts. The system may also give an option for the user to expand the search to 2^{nd} degree contact reviews and 3^{rd} degree contact reviews and also reviews in the entire network. The user may decide to narrow the scope of hotels listed in terms of value, proximity, reviews received, incentives offered and the type of users, who have reviewed. With each selection the user is narrowing down the available results to a manageable number for final analysis.

2.7 The user chooses a hotel.

2.8 The hotel data is displayed along with relevant facts to assist the user in planning his stay, check in time, additional systems. If the hotel is set up in the system as a commercial partner user the user may have the ability to book the room via the system app. The user may also have the option to contact the hotel directly.

2.9 The user stays in the hotel and then checks out.

2.10 The user can decide to give the hotel a review or not.

2.11 The user decides not to give the hotel a review.

2.12 The user decides to give the hotel a review. If the user is in the hotel the system app, if activated while in the hotel, will display the review data for the hotel and ask the user, prompted by a default category, to decide how happy they were with the hotel.

2.12.1 The user decides that the Hotel is the best budget hotel in Paris. The review is published, within user and system policy guidelines.

2.12.2 The system will alert the hotel that a user review was acted upon by a new user and that user decided to give the hotel a review too. The hotel can, if it wishes, award the seeding review user with a reward and or a gratuity.

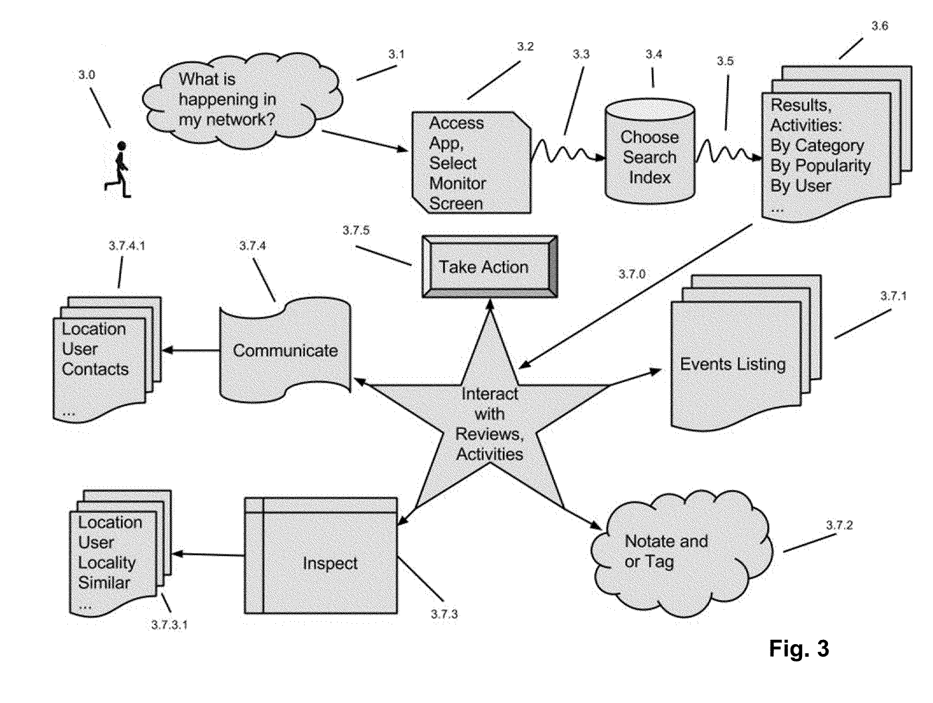

FIG. 3. FIG. 3 presents an example of a systems review monitoring and review communication system according to various embodiments described herein.

3.0 A user registers as a registered user with the system.

3.1 The user wishes to find out up to date information regarding reviews being submitted within his direct network or general reviews being submitted for his locality or a locality he has an interest. He may also wish to review activity for any category that relates to his interests. In this case he wishes to merely see what his connected users are reviewing and what comments or conversations they are having.

3.2 He accesses the system application (app) on his device. He selects his monitor screen.

3.3 The system app may query the system database and retrieved data pertinent to the logged in users network where he has authority to review.

3.4 The user selects the search parameter desired. He can query the system database of reviews using any number of indexed search queries such as reviews by category, by popularity, by specific users, or any embodiment of the data schema.

3.5 The user's request is transmitted to the system database and data is returned to the system app.

3.6 The system app may display the data received. The user can apply a sort to the data received. He may wish to see the data by time or by proximity to his current location or any other indexed field within the data set.

3.7.0 The user now has a list of recent reviews displayed on his device. With the list of reviews and activity he can choose to interrogate the results further.

3.7.1 He can seek to see a list of events or in the case of products a list of product providers that have garnered reviews and supply the system or product he is interested in. The list of events might be displayed in terms of category or proximity to his physical location or in terms of temporal proximity. For example a list of Jazz musical concerts over the next month within 100 Km of his location.

3.7.2 For any event of review or location or provider or reviewer the user may wish to tag the entry as being of interest. He can add it to his calendar; he could wish to be reminded should he be within range of the location in the future or if the location offers a special offer. He may wish to be added to the system provider's notification list.

3.7.3 He can open up a specific listing and delve into the detail of what was reviewed, under what category, by whom.

3.7.3.1 The user can uncover various layers of related data, other reviews by the reviewer, other similar locations that have been reviewed under that category, lists of other networked users that have given reviews of the location. Because the review held within a relational database multiple related tables of data are connected and as such the user can start a journey through various data sets of information all triggered by one data entry point.

3.7.4 The user may wish to interact with the provider of the product or the system being reviewed for any number of reasons.

3.7.4.1 The user may wish to communicate with a provider of a reviewed location on the basis of an item of clothing sold. They may have a query regarding similar items of clothing that the user may have an interest in. The user may wish to ask a question of the reviewer, to enlarge on a detail or to swap pointers or experiences.

3.7.5 The user may wish to act upon a review; and make a booking, buy a song, buy a product or any other action that could allow them to act upon the recommendation.

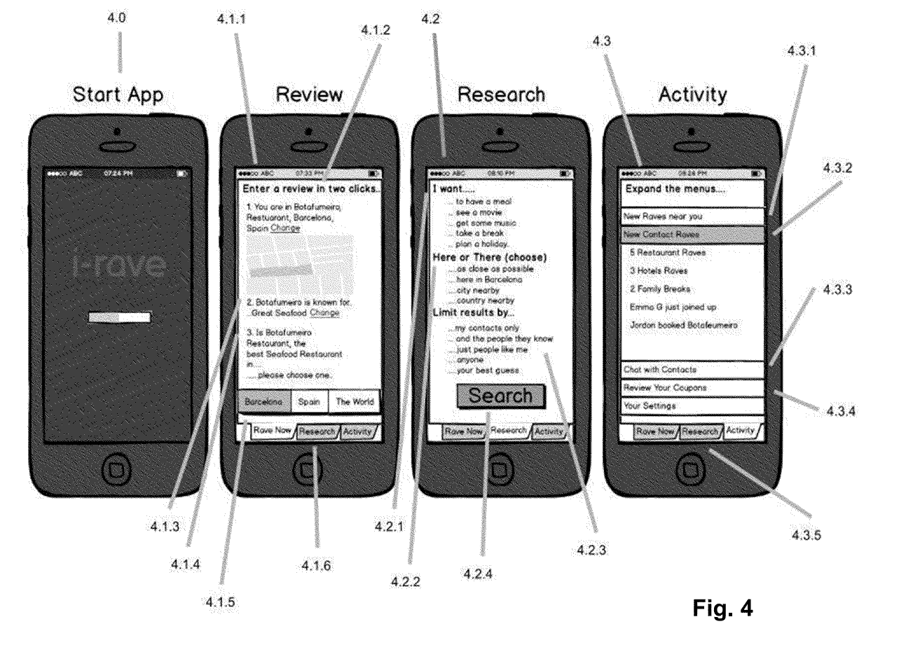

FIG. 4. FIG. 4 presents an example of a mockup of a mobile system application on a mobile computing device according to various embodiments described herein.

4.0 The user starts up the application.

4.1.1 This is the first screen that the user will see. It allows the user to start a review process. The system app may populate this screen by identifying the location of the user, cross referencing with a database of locations and display the results of where the system believes the user is located.

4.1.2 The system app displays the name and location of the business where the user is located. An option is given to allow the user to change the location and business being listed.

4.1.3 The system app displays the category that it believes the location is most commonly associated with. The user can change the category of they wish.

4.1.4 The system app makes a statement based on the input in the previous sections 4.1.2 and 4.1.3.

4.1.5 The system app prompts the user to select which geographical limit to file the review under.

4.1.6 The system app contains a menu of options to allow the user to select further core functionality such as research functions and activity functions.

4.2 This is the research screen.

4.2.1 This first step prompts the user to identify what type of information they are seeking. The categories may be adapted to specific audiences.

4.2.2 This section prompts the user to identify the geographical limits within the search parameter. In the case of a media the limitation could be based on a chronological basis.

4.2.3 This section requests the user to define how wide a contact base should the query or search is limited to. Users can limit to just contacts that they know or wider the contacts of the contacts that they know. They can also widen the search to unconnected parties.

4.2.4 Once the sections are complete the client can search the database of reviews and review choices available. If they wish they could return to the search screen and make change to the search criteria.

4.3 This section displays the activity or monitoring and communications function.

4.3.1 The user may list reviews that are happening within their locality, this might prompt them to explore new places or enjoy new experiences.

4.3.2 The user can explore reviews that have happened within their contact network. This section can display status information within a known contact list.

4.3.3 The user may wish to communicate via text or by someone other electronic means via the system app with known contacts.

4.3.4 The user may have been rewarded gratuities from participating users and may wish to inspect what they have received.

4.3.5 The user may also adjust personal account setting governing their account such as posting rules, review settings and transparency controls.

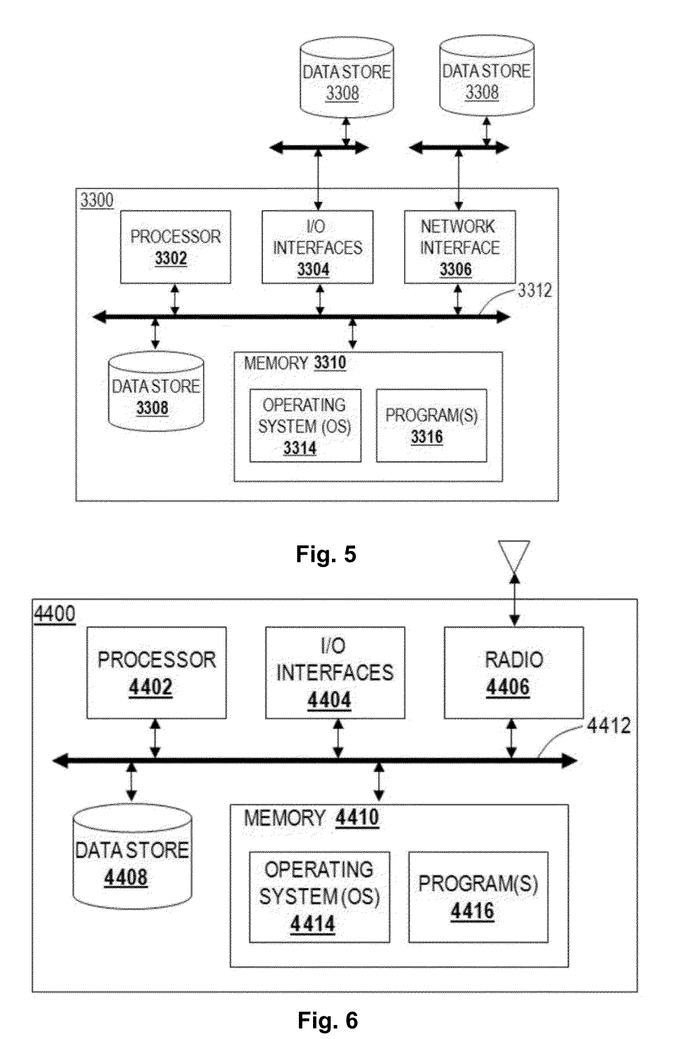

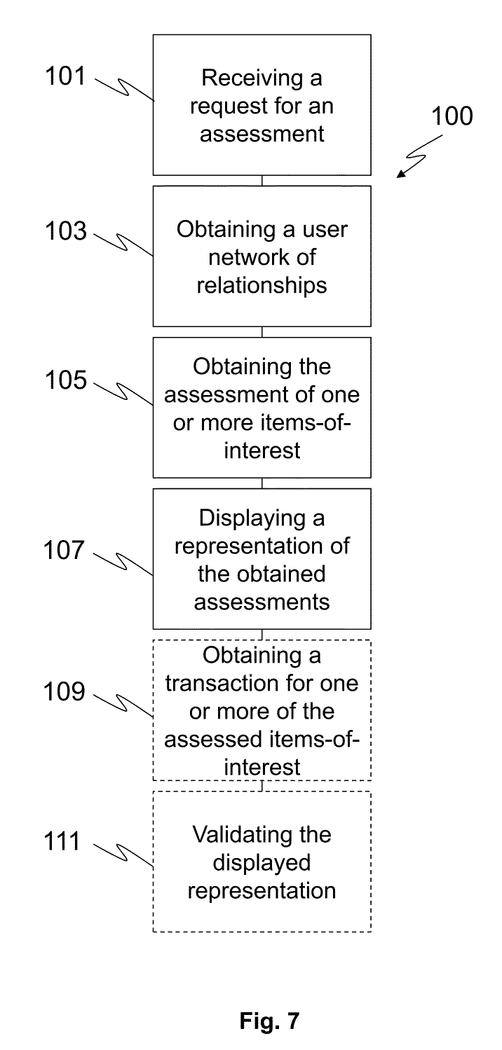

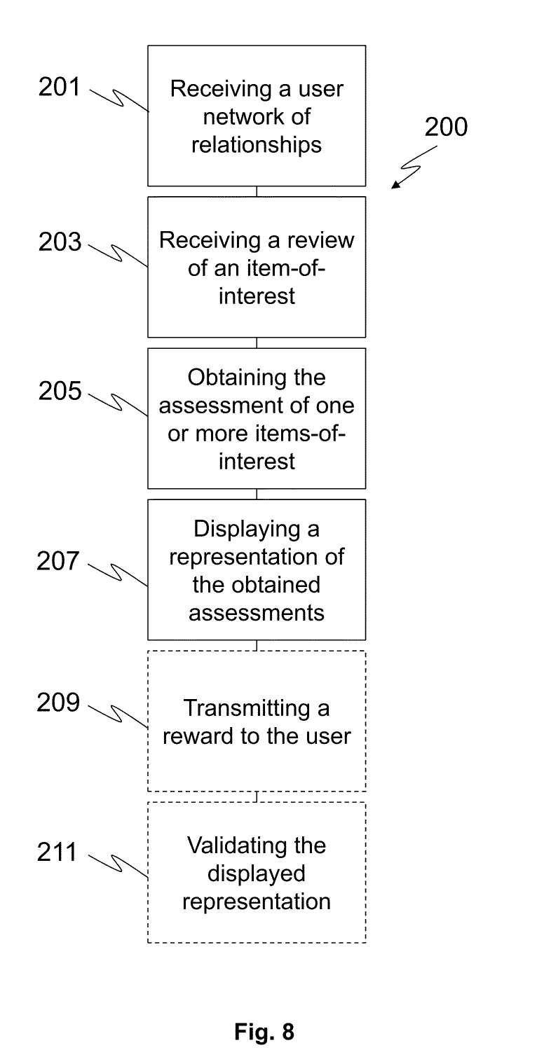

Referring to FIG. 5, in an exemplary embodiment, a block diagram illustrates a server 3300 which may be used in the system 100, in other systems, or standalone. The server 3300 may be a digital computer that, in terms of hardware architecture, generally includes a processor 3302, input/output (I/O) interfaces 3304, a network interface 3306, a data store 3308, and memory 3310. It should be appreciated by those of ordinary skill in the art that FIG. 5 depicts the server 3300 in an oversimplified manner, and a practical embodiment may include additional components and suitably configured processing logic to support known or conventional operating features that are not described in detail herein. The components (3302, 3304, 3306, 3308, and 3310) are communicatively coupled via a local interface 3312. The local interface 3312 may be, for example but not limited to, one or more buses or other wired or wireless connections, as is known in the art. The local interface 3312 may have additional elements, which are omitted for simplicity, such as controllers, buffers (caches), drivers, repeaters, and receivers, among many others, to enable communications. Further, the local interface 3312 may include address, control, and/or data connections to enable appropriate communications among the aforementioned components.

The processor 3302 is a hardware device for executing software instructions. The processor 3302 may be any custom made or commercially available processor, a central processing unit (CPU), an auxiliary processor among several processors associated with the server 3300, a semiconductor-based microprocessor (in the form of a microchip or chip set), or generally any device for executing software instructions. When the server 3300 is in operation, the processor 3302 is configured to execute software stored within the memory 3310, to communicate data to and from the memory 3310, and to generally control operations of the server 3300 pursuant to the software instructions. The I/O interfaces 3304 may be used to receive user input from and/or for providing system output to one or more devices or components. User input may be provided via, for example, a keyboard, touch pad, and/or a mouse. System output may be provided via a display device and a printer (not shown). I/O interfaces 3304 may include, for example, a serial port, a parallel port, a small computer system interface (SCSI), a serial ATA (SATA), a fiber channel, Infiniband, iSCSI, a PCI Express interface (PCI-x), an infrared (IR) interface, a radio frequency (RF) interface, and/or a universal serial bus (USB) interface.

The network interface 3306 may be used to enable the server 3300 to communicate on a network, such as the Internet, a wide area network (WAN), a local area network (LAN), and the like, etc. The network interface 3306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 3306 may include address, control, and/or data connections to enable appropriate communications on the network. A data store 3308 may be used to store data. The data store 3308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 3308 may incorporate electronic, magnetic, optical, and/or other types of storage media. In one example, the data store 3308 may be located internal to the server 3300 such as, for example, an internal hard drive connected to the local interface 3312 in the server 3300. Additionally in another embodiment, the data store 3308 may be located external to the server 3300 such as, for example, an external hard drive connected to the I/O interfaces 3304 (e.g., SCSI or USB connection). In a further embodiment, the data store 3308 may be connected to the server 3300 through a network, such as, for example, a network attached file server.

The memory 3310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 3310 may incorporate electronic, magnetic, optical, and/or other types of storage media. Note that the memory 3310 may have a distributed architecture, where various components are situated remotely from one another, but can be accessed by the processor 3302. The software in memory 3310 may include one or more software programs, each of which includes an ordered listing of executable instructions for implementing logical functions. The software in the memory 3310 includes a suitable operating system (0/S) 3314 and one or more programs 3316. The operating system 3314 essentially controls the execution of other computer programs, such as the one or more programs 3316, and provides scheduling, input-output control, file and data management, memory management, and communication control and related services. The one or more programs 3316 may be configured to implement the various processes, algorithms, methods, techniques, etc. described herein.

Referring to FIG. 6, in an exemplary embodiment, a block diagram illustrates a mobile device 4400, which may be used in the system 100 or the like. The mobile device 4400 can be a digital device that, in terms of hardware architecture, generally includes a processor 4402, input/output (I/O) interfaces 4404, a radio 4406, a data store 4408, and memory 4410. It should be appreciated by those of ordinary skill in the art that FIG. 6.0 depicts the mobile device 4400 in an oversimplified manner, and a practical embodiment may include additional components and suitably configured processing logic to support known or conventional operating features that are not described in detail herein. The components (4402, 4404, 4406, 4408, and 4410) are communicatively coupled via a local interface 4412. The local interface 4412 can be, for example but not limited to, one or more buses or other wired or wireless connections, as is known in the art. The local interface 4412 can have additional elements, which are omitted for simplicity, such as controllers, buffers (caches), drivers, repeaters, and receivers, among many others, to enable communications. Further, the local interface 4412 may include address, control, and/or data connections to enable appropriate communications among the aforementioned components.

The processor 4402 is a hardware device for executing software instructions. The processor 4402 can be any custom made or commercially available processor, a central processing unit (CPU), an auxiliary processor among several processors associated with the mobile device 4400, a semiconductor-based microprocessor (in the form of a microchip or chip set), or generally any device for executing software instructions. When the mobile device 4400 is in operation, the processor 4402 is configured to execute software stored within the memory 4410, to communicate data to and from the memory 4410, and to generally control operations of the mobile device 4400 pursuant to the software instructions. In an exemplary embodiment, the processor 4402 may include a mobile optimized processor such as optimized for power consumption and mobile applications. The I/O interfaces 4404 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, and the like. The I/O interfaces 4404 can also include, for example, a serial port, a parallel port, a small computer system interface (SCSI), an infrared (IR) interface, a radio frequency (RF) interface, a universal serial bus (USB) interface, and the like. The I/O interfaces 4404 can include a graphical user interface (GUI) that enables a user to interact with the mobile device 4400. Additionally, the I/O interfaces 4404 may further include an imaging device, i.e. camera, video camera, etc.

The radio 4406 enables wireless communication to an external access device or network. Any number of suitable wireless data communication protocols, techniques, or methodologies can be supported by the radio 4406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 4408 may be used to store data. The data store 4408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 4408 may incorporate electronic, magnetic, optical, and/or other types of storage media.

The memory 4410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 4410 may incorporate electronic, magnetic, optical, and/or other types of storage media. Note that the memory 4410 may have a distributed architecture, where various components are situated remotely from one another, but can be accessed by the processor 4402. The software in memory 4410 can include one or more software programs, each of which includes an ordered listing of executable instructions for implementing logical functions. In the example of FIG. 6.0, the software in the memory 4410 includes a suitable operating system (O/S) 4414 and programs 4416. The operating system 4414 essentially controls the execution of other computer programs, and provides scheduling, input-output control, file and data management, memory management, and communication control and related services. The programs 4416 may include various applications, add-ons, etc. configured to provide end user functionality with the mobile device 4400. For example, exemplary programs 4416 may include, but not limited to, a web browser, social networking applications, streaming media applications, games, mapping and location applications, electronic mail applications, financial applications, and the like. In a typical example, the end user typically uses one or more of the programs 4416 along with a network such as the system 100.

The following is one possible embodiment of a system process for the provision of a review services to a user of the system. The system may start up by a user invoking a mobile system application resident on an internet connected device. The application presents a logic decision determining if the current user operating the system application is known and if the credentials provided are valid. If the user account is not known or cannot be validated the sign-up process will be invoked. In this step the user is passed through an account creation process. Or if the credentials have been lost and or forgotten a credential reminder process is followed.

If the user is known and the credentials given are accurate the system may log in the user and ask the user to select which function they wish to follow. In this embodiment the options given are, but are not limited to, Review; Search, and Monitoring. In this example the option chosen is Review, where by the user wishes to make a review of a location or a service.

The system may ascertain the location of the mobile device being used to access the service. A mobile device will be able to provide the system with location coordinates for the user location. If the service is available the information will be acted upon to query a database of locations, which match the coordinates received. Where the location coordinates are not available, due to poor coverage our an inability to access the mobile device location service, the user will be prompted to provide the location. The user may enter the location in any number of ways, such as by location name, township, street, zip code, GPS coordinates. The system may display the location data for the coordinates given. Where a default category is available the system may display it. The system may ask the user if the location and its default category are acceptable. Where the location and or the category are not acceptable the user may be given the option of changing the values by entering in their own or searching for alternative values.

Once the location and category are acceptable the system may then prompt the user to decide how relevant the category is for the location being reviewed in terms of importance by deciding that within a given increasing range of physical space the review is relevant. For example the system may give options for which the review is relevant as being the users favorite location for a given category for the city, the country or the world. In the embodiment of a service, which does not require physical location to be relevant the range of values, is given in terms of temporal space. For example where a song or artist is being reviewed the range of relevancy might be expressed in terms of; now, this year, all time.

The user may also select the desired level of physical relevancy. The system will record the review and all data relating to the user, the location where the review was made, the time made and will save to the system database. The review may be published to the system. All connected parties will be able to view the review, analyze it, communicate, and comment with the reviewer and the location, tag and notate it as being important.

The review may be published subject to the reviewer account setting options which may manage the method and manner of review postings. Where reviewer's contacts or the locations followers or other interested parties have requested that should a new review be posted, they will be actively notified via an alert within the system application. The review may also be published to other social media channels either via the reviewers account or the locations accounts or other interested accounts. The review process may be finished once a review has been published. The user may wish to create another review or access other services within the system or interact with the readers of the review via chat functionality.

Another example presents a possible embodiment of a system process for the provision of a search services to a user of the system. Like above, the system may start up by invoking a mobile system application resident on an Internet connected device. A logic decision determines if the current user operating the system application is known and if the credentials provided are valid. If the user account is not known or cannot be validated the sign up process will be invoked. In this step the user is passed through an account creation process. Or if the credentials have been lost and or forgotten a credential reminder process is followed.

If the user is known and the credentials given are accurate the system may log in the user and ask the user to select which function they wish to follow. In this embodiment the options given are, but are not limited to, Review; Search, and Monitoring. In this example the option chosen is Search, where by the user wishes to search for information.

In one such embodiment the user decides on which parameters they wish to search under. The system may prompt the user to search for either an activity type (swimming, a great walk), a reviewer (John Porter), a product (a shirt), a service (hairdresser/plumber), a descriptor (movie, Italian food, a romantic spot). Once the type of service, product or activity is selected, the system may then request a physical dimension to be searched (a city, a town).

The system may display the results of the search to the user. The results may be displayed in terms of physical proximity, relative value based on previous users who's reviews where greatly valued by virtue of the user interacting with them. They may also be displayed by any other categorization, which can enhance the user experience. The display of results may be controlled by user preferences.

The user may select one of the reviews displayed. The user may decide to access a particular review and review the details of all aspects to the review. This may involve ancillary information about the reviewer, the locations review history, contact details, offers, booking processes, communication channels with the reviewer and or the location. The system may give the user a series of options once they are accessing the detail of a review. In this embodiment the user has a choice of ways they can interact. For example, the user may review any aspect of the review and related datasets of the review. This may include all the reviews of a location, historical review trends. Details of the reviewer and any other reviews that they may have made that are available. For example in one such embodiment a reviewer may be very valued by their contacts and may have a score calculated by the system that implies that they are very well thought of and the reviews that they give are to be trusted.

The user can tag a review under a set of categorizations which they may set themselves. For example in one such embodiment a user may note a review made that indicates a great shop to buy shirts. The reviewer notes the review as a having relevancy for them under “places to shop”. They can then refer back to this category when they wish to go cloth shopping in the future.

The user may communicate with the parties to the review. This may include the location being reviewed, the reviewer or others who have commented on the review. The ability to communicate will be governed by relevant user privacy settings. The user may wish to avail of the location services and process a transaction with the location. The user can then exit the system or to search again for another review or category of reviews.

### Further Exemplary Embodiments

In some embodiments, the system may allow users to record reviews on their favorite provider, and the system may have multiple primary uses; Processing Reviews, Processing Research Requests, Monitoring, and Interacting with Reviews.

If the provider being reviewed has a physical presence (a shop) the review may be recorded as their favorite, for a given category, for a given geographical location.

If the provider or work of the provider is being reviewed does not have a physical presence and is of a system, or media, nature then the review can be given on the basis of time or within a specific time frame with or without reference to physical reference location data, for example, favorite music album this year in the United Kingdom.

### User Case Exemplary Embodiment

### Signing Up for the System

A user can download the system by installing the system on a mobile device or signing up by visiting the systems website. Most users are anticipated to sign up via a downloaded application on their mobile device. A user may see an associate post a message on Facebook or Twitter or receive an email notification of a review being posted online by an associate of theirs or about a location with which they are familiar. By clicking on the link embedded in the message they will load up the application, if it is installed on their device and if not installed they will be prompted to install the system and set up an account.

Once a user downloads the system they will be invited to sign up for an account. The system will seek permission to access the users social media accounts and email address book as well as any address book on the device. The system will seek to establish which users are known to the user signing up and are already users of the system. The system may display a list of known users and ask which ones the user would like to follow. For all users selected the system may send a notification that the new user is seeking to follow them and ask if the follow request will be allowed and reciprocated. For all users not known on the network the system may ask the user do they wish to be invited to become users of the system too. Whichever are selected an invitation may be sent stating that the new user is a user of the system and that they should consider joining too.

The user will be allowed to establish user settings governing personalization of the system and how new reviews should be distributed on the network. For example a new user may opt, within a user review settings screen, to restrict reviews being shown to a limited number of 1^{st} degree contacts and no contacts beyond that. In essence 2^{nd} degree contacts would not be able to see where a review came from. In some embodiments the system may allow second-degree and beyond contacts to see some user credential such as a screen name attributable to the reviewing user. A user may opt to have reviews published globally but with a time delay, for example a few days, in order to ensure that a review publishing their location does not inadvertently create a security risk to the reviewer flagging where they are located and more importantly where they are not located. Without such a mechanism a user could by placing a review flag to a criminal that the reviewers home is unattended and could be subject to a robbery.

### Use Case Exemplary Embodiment

### Processing Reviews for a Physical Location of Interest

In this example, User A is a well-traveled and educated businessperson. User A is visiting Barcelona on business. He has dinner with a colleague in a famous seafood restaurant “Botafumeiro”. A lover of food, he does not know what to expect. The meal he has surpasses all expectations. For him it is a meal he will never forget and he knows he will refer back to the meal when he gets home, indeed he plans to take special note of the restaurant, the dish and direct friends to visit there should they be coming to Barcelona and ask his advice. In order for his friends to benefit from his experience he will have to be fortunate to be in their company prior to their visit and to remember to recall his experience and they will have to remember to make a note to visit. A lot has to happen for the valuable experience registered by User A to have any positive impact. He decides that right now, this is his favorite seafood restaurant ever. He wants to “Rave” about it, knowing that the restaurant may benefit from his endorsement and his friends will definitely benefit from eating there, so very simply, he does the following: He opens up his application of the system on his mobile phone or other Internet connected device (Click One), see 1.3. Instantly the following happens; (1) the system locates him via GPS, (2) the system suggests that he is in Botafumeiro Restaurant, Barcelona, See 1.4, (3) the system suggests that he wishes to give the restaurant an categorized review for “Best Seafood Restaurant”.

He now needs to decide if it is the best restaurant generally, or specifically for Fish or some other sub category, the most popular are listed. If he is happy with the general listing, he now needs to make one further decision, is it the best restaurant in Barcelona, Spain or The World. The system has three simple images that depict his options; local (Barcelona), country (Spain) or the globe (the world). He selects the globe. (Click—Two), see 1.5.

If he wishes he could enhance his review by adding sound, images and text. In this case he selects the basic review. The system updates and the endorsement is registered. The rating took less than a few seconds to process. In as little as two actions or clicks and he can be finished, see 1.12.

### Use Case Exemplary Embodiment

### Processing Reviews for a Non-Physical System of Interest

In this example, User B is a busy executive and avid music fan. She loves to take time out of her busy workday and meet with friends and relax. On occasion she and her friends will talk about various TV shows that they have been watching or a musical album that someone has discovered. User B's friends love to get tips from her as to the best music to listen to or which musical acts to follow. User B enjoys departing musical knowledge to her friends. While browsing you tube User B came across a new band that had released a cover version of one of her favorite rolling stone songs. She really loved the cover and decided to give them a review. She accessed her browser based plug-in of the system. The system opened up and recognized the web page she was visiting and the band that she was listening to. The system listed the band and displayed statistics about recent reviews that they had received. Previous reviewers had input the categories listed and the one that was most popular was best “Rolling Stones Tribute Act”. Mary decided that she agreed with the category suggested. The only input needed now was for her to decide just how good the band was in terms of time. She decided, that for the category chosen, they were the best she had heard ever. The system gave her three simple choices, favorite: Now, This Year or Ever, see 1.10. She chose “Ever”, see 1.11.

### Use Case Exemplary Embodiment

### After a Review is Made

Once a user review is made connected parties will have their monitoring feed of updates updated. For example, in User A's case the review for the restaurant in Barcelona was applied instantly to the feed of all his followers. The information given to them will tell them where he was, what he reviewed and how well he thought of it. The feed will allow those following him to comment back to User A via his review. A friend may comment that they too had been there and loved it, or someone else might suggest a great bar that he should visit that is very nearby. In effect a very simple review operation may well prompt a tribe of connected like-minded individuals to intellectually converge on a person and their location and provide valuable insights as to the location in addition to absorbing benefit from the reviewing parties experiences.

User A's user setting will allow him to control how his reviews are released. He can choose to release on a timed basis so security concerns regarding his being away from home may be alleviated. He may not wish people to comment on his reviews publically rather he may only want followers to message directly to him.

Once the review is published an anonymous version of the review will also be made available to the entire network. Individuals who do not know anyone who have reviewed a city but would like good information, as to where to go and what to see, will use this system.

Locations receiving reviews may be ranked in charts of increasing in popularity or decreasing in popularity. User A's restaurant may have only suddenly started attracting attention and thus it would be ranked as a new and rising star in the restaurant category. Likewise other restaurants that failed to wow clients and subsequently started to receive less favorable reviews would start to fall in ranking.

Locations may also be evaluated on the basis of how great they are nationally or globally or citywide. This analysis could super charge certain locations as being world champions in their own category. Rankings could be provided on an annual basis so that for a particular category one restaurant was the most favored in a particular year. This in itself could revolutionize the concept of critic reviews and how they operate.

Should one of User A's contacts act upon his review and visit the restaurant they may be able to avail of an incentive provided by the restaurant as thanks to User A. Should the contact also endorse the restaurant with a review the restaurant may award User A with a reward for his review and the subsequent business earned as a result. It is important that User A not be rewarded directly for his initial review; otherwise reviews will only be made on the basis of receiving rewards.

All users that follow the User A will be updated via their feed of user activities to the review. More importantly whenever one of them is in Barcelona and is seeking a steer on where to eat they can open the app and get peer based suggestions. If a user is planning a trip to Barcelona the system may interact with a flight engine and suggest an itinerary of peer reviewed activities.

### User Case Exemplary Embodiment

### The System as a Research Tool

In this example, User C is visiting Paris on business. He decides to make a weekend out of it and bring his wife. He wants to book a good value romantic hotel near the Eiffel tower. He opens up an application of the system, selects Research tab, and states that he is looking for accommodation, in Paris, see 2.2.

The system shows three options based on 1^{st} degree contact reviews (people on the network that he knows specifically first hand). He has the option of expanding out the search to 2^{nd} degree contacts (people on the network that know his first degree contacts but not him directly). He can also ask the system to make suggestions based on this system's best guess. The system in this case will use User C's profile data to present options of other individuals in the network that share similar traits to User C, see 2.6.

One review shows that if a booking is made using a loyalty code where he can save an extra 15% on the booking cost.

He decided to expand the search out even further and sees that for people of his profile there seems to be consensus around one boutique hotel which also offers a coupon, see 2.7. He hits the booking button and inputs his details, shortly afterwards his booking completes, see 2.8.

The benefit for User C is that the data is real and verifiable, up to date and relevant as it comes from people in his circle or circles inhabited by people like him. The review of a retired Australian couple last year is not as valuable as his bank manager who is the same age as him or his best man, who works in London.

The system can be used to monitor and comment upon reviews made within ones network. As the network posts reviews each review will be added to the users list of new reviews. Category, number, distance or reviewer will sort reviews. New reviews can be opened and read. If the review was prompted by another review then a reward may have been earned.

### User Case Exemplary Embodiment

### Monitoring and Interacting with Other User Activities

Users will be able to monitor the views of connected parties. Reviews may be displayed under a variety of different headings; reviewer, categories, proximity to the user, trending locations, trending categories, and suggested, popular choices, see 3.2 & 3.6.

Viewers will be able to open up a specific review and assess the value of the review; they may decide to look into the location and all reviews for that location, trends for that location over time. Viewers may want to look into the reviewer and study information about them, what they have reviewed, see 3.7.3.1.

Viewers may also comment on the review privately or publically. They may wish to ask the reviewer to clarify an aspect of the review or they may wish to depart additional interesting facts, see 3.7.4.

Viewers may wish to tag the review for future consideration. The system may then remind them that they should visit the location should they be passing by the area where the location is based, FIG. 3.7.2.

A user may wish to be added to a reviewed locations marketing list and be notified of events and offers. They can request this while reviewing the list. By tagging their wish the commercial user, who is associated with the location, will be provided with the users details and the ability to send communications via the system to the user. This function will require the commercial user to be registered with the system and be in compliance with requisite data protection policies, see 3.7.4.1.

The user may also review events being organized by locations in their locality or a locality of their choice over a specified time frame. They may decide they wish to attend the event and select an invitation detailed on the events list. They may decide to broadcast their intention to attend the event to their network and in doing so prompt others to attend too, FIG. 3.7.1.

Viewers may be able to see shared contacts with the reviewer and as such may see the comments made by contacts common to both.

Monitoring may also provide a list of popular locations and activities, systems amongst the network or the wider network of interesting and trending locations. This may aid users in the discovery of new and relevant locations and services. The system may use its own algorithm to tailor results for the user logged in. For example teenage driven content will not be served up to middle-aged men, see 3.7.1.

### User Case Exemplary Embodiment

### Commercial Listings

Another user type for the system will be company's whose businesses become listed or any embodiment of a related party connected to a location or service. Many locations will be listed to start with and they will have cursory details in terms of location references, categories and contact details where available, number and nature of reviews received.

Businesses may wish to avail of an enhanced listing, which will unlock a number of key system options to the owners. They may be able to make offers to reviewers within certain parameters set by the reviewer. For example one special offer each month.

They may be able to send rewards to seed reviewers if their review led to another customer visiting the location.

They may be able to take bookings from the system. Should a networked reviewers review be seen by a networked contact that network contact may be able to click in the review and with a number clicks and choices be able to make a reservation at the location, by stating desired dates. Indeed the business may be able to convey a discount to the friends of the reviewer for first time visits in order to build up a customer acquiring viral effect off the back of the review.

The company listing may also allow clients to pay for their bill over the system. The system may allow standard payment methods such as credit cards and debit cards, in addition to electronic currency systems, such as Bitcoin or via a bespoke, system managed, crypto currency.

One embodiment may be described as a method for the collection from a person or other entities, reviews, with categorization, for a unique and specific physical location or area, where the reviews relevancy is recorded in terms of degrees of geographical proximity and the time made. The method may further comprise providing related parties of review authors access to author reviews by means of electronic database search. The method may further comprise whereby authors of reviews, of commercial services and products experienced and acted upon by connected parties, may receive a gratuity in compensation by services and or product providers for giving a review.

Another embodiment may be described as a method for the collection from a person or other entities, reviews, with categorization, for a unique and specific temporal value, where the reviews relevancy is recorded in terms of degrees of temporal proximity and time made. The method may further comprise providing related parties of review authors access to author reviews by means of electronic database search. The method may further comprise whereby authors of reviews, of commercial services and products experienced and acted upon by connected parties, may receive a gratuity in compensation by services and or product providers for giving a review.

Although the present disclosure has been described with respect to one or more particular embodiments, it will be understood that other embodiments of the present disclosure may be made without departing from the spirit and scope of the present disclosure. Hence, the present invention is deemed limited only by the appended claims and the reasonable interpretation thereof.

What is claimed is:

1. A method performed by a computing system for providing distribution and communal analysis of customer reviews, the computing system having a processor and a memory, the method comprising:
receiving a request for an assessment of items-of-interest within a geographic area or chronological space, the request comprising a category and a requesting-user identifier;
obtaining, by the computer system, a user network of relationships between the requesting-user identifier and other user-identifiers;
obtaining, by the computing system, the assessment of one or more items-of-interest, each assessment comprising a score, wherein:
the score is based in part on the requested category;
the score is based in part on the geographic area or chronological space;
the score is based in part on reviews of the items-of-interest from the other users in the user network, the reviews of the other users stored in a computer-accessible database, each review weighted based on a hierarchical relationship between each other user and the requesting-user identifier in the user network;
displaying, by the computing system, a representation of the obtained assessments.

2. The method of claim 1, wherein the item-of-interest is a restaurant.

3. The method of claim 1, wherein the item-of-interest is a song.

4. The method of claim 1, wherein the geographic area is a city.

5. The method of claim 1, wherein the chronological space is one year, one month, or one day.

6. The method of claim 1, wherein the assessments are displayed based on a degree of relationship within the user network.

7. The method of claim 1, further comprising:
obtaining, by the computer system, a transaction for one or more of the assessed items-of-interest.

8. The method of claim 1, further comprising:
validating, by the computer system, the displayed representation based on geographic data or chronological data from the computing system.

9. The method of claim 1, wherein the score is further based in part on the geographic proximity between the user and the item-of-interest.

10. A method performed by a computing system for providing distribution and communal analysis of customer reviews, the computing system having a processor and a memory, the method comprising:
receiving, by the computing system, a user network of relationships between a requesting user and other users;
receiving, a review of an item-of-interest within a geographic area or chronological space, the review comprising a category, corresponding physical location, and a relevancy score, wherein the relevancy score is based on the geographical and chronological proximity to the item-of-interest;
obtaining, by the computing system, the assessment of one or more items-of-interest, each assessment comprising a score, wherein:
the score is based in part on the received category; and
the score is based in part on the received geographic area or chronological space;
displaying, by the computing system, a representation of the obtained assessments.

11. The method of claim 10, further comprising:
transmitting a reward to the user based on the received review.

12. The method of claim 10, further comprising:
validating, by the computer system, the review based on geographic data or chronological data from the computing system.
